(19) United States
(12) Patent Application Publication
(10) Pub. No.: US 2020/0001246 A1
(43) Pub. Date: Jan. 2, 2020

(54) Membranes

(71) Applicants: Fujifilm Manufacturing Europe B.V., Tilburg (NL); Fujifilm Corporation, Tokyo (JP)

(72) Inventors: Erik Vermeer, Tilburg (NL); Yujiro Itami, Tilburg (NL); Takeshi Umehara, Tilburg (NL)

(21) Appl. No.: 16/484,594

(22) PCT Filed: Feb. 21, 2018
(86) PCT No.: PCT/GB2018/050453

§ 371 Date: Aug. 8, 2019

(30) Foreign Application Priority Data
Feb. 23, 2017 (GB) 1702883.8

(51) Int. Cl. B01D 69/12; B01D 53/22; B01D 71/64; B01D 67/00

(52) U.S. Cl. CPC B01D 69/127; B01D 53/228; B01D 2323/345; B01D 67/009; B01D 2313/44; B01D 71/64

(57) ABSTRACT

A process for preparing a membrane comprising applying a composition comprising a polyimide to a gas-permeable support and irradiating the composition with UV-C light source to form a discriminating layer on the support, wherein: (i) the UV-C light source emits light having a wavelength in the range 200 to 280 nm; (ii) the irradiation is performed for a period of time in the range 0.05 to 60 seconds; and (iii) the irradiation is performed at a power intensity of at least 20 mW/cm² and no more than 250 mW/cm²

This invention relates to membranes and to their preparation and use for the separation of gases.

Membranes comprising a gas-permeable support (e.g. a porous layer and a gas-permeable polymeric layer (often referred to as a “gutter layer”)) and a discriminating layer are known in the art. Each of these components are important contributors to the overall performance of the membrane. The porous layer provides the membrane with mechanical strength; the discriminating layer selectively allows some gases to permeate more quickly than others; while the gutter layer, when present, provides a smooth, gas-permeable intermediate surface between the porous layer and the discriminating layer.

Typically a mixture of gasses is brought into contact with one side of the membrane and at least one of the gases permeates through its discriminating layer faster than the other gas(es). In this way, an initial gas stream is separated into two streams, one of which is enriched in the selectively permeating gas(es) and the other of which is depleted in the selectively permeating gas(es).

One of the problems faced when using gas separation membranes is that the gases they come into contact with are often ‘dirty’ due to the environment in which they are used. For example, the gases contain significant quantities of higher hydrocarbons that damage membranes. Dirty gases can cause premature plasticization of the membranes and thereby reduce the membrane's selectivity. Another problem gas-separation membranes suffer from is the occurrence of cracks, particularly when the membrane is being used at a high pressure. These cracks undermine the selectivity of the membrane, allowing gases to pass through indiscriminately. There is a need for membranes which have a low tendency to crack and which retain good selectivity even when they have been in contact with dirty gases and/or are used at high pressure.

According to a first aspect of the present invention there is provided a process for preparing a membrane, the process comprising applying a composition comprising a polyimide to a gas-permeable support and irradiating the composition with a UV-C light source to form a discriminating layer on the support, wherein:
(i) the UV-C light source emits light having a wavelength in the range 200 to 280nm;
(ii) the irradiation is performed for a period of time in the range 0.05 to 60 seconds; and
(iii) the irradiation is performed at a power intensity of at least 20 mW/cm² and no more than 250 mW/cm2.

The gutter layer may also be referred to as a layer of cured polymer, but for brevity in this specification we usually refer to it as a “gutter layer” or “GL”. Also in this specification the discriminating layer is sometimes abbreviated to DL and the protective layer is sometimes abbreviated to “PL”.

### BRIEF DESCRIPTION OF THE DRAWING

The present invention will be discussed in more detail below, using a number of exemplary embodiments, with reference to the attached drawing, in which:

FIG. 1 shows the emission spectrum of a H-bulb (mercury vapour) which strongly emits light in the UV-C wavelength range of 200 to 280nm.

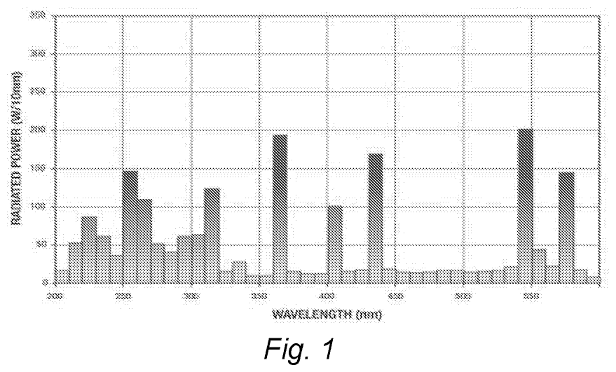

The primary purpose of the gas-permeable support (abbreviated to “support” hereinafter) is to provide mechanical strength to the discriminating layer without materially reducing gas flux through the membrane. Therefore the support is typically open-pored relative to the discriminating layer.

Preferably the support comprises a porous layer and a gutter layer, wherein the gutter layer is present on the porous layer.

The porous layer may be, for example, a microporous organic or inorganic membrane, or a woven or non-woven fabric. The porous layer may be constructed from any suitable material. Examples of such materials include polysulfones, polyethersulfones, polyimides, polyetherimides, polyamides, polyamideimides, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile.

One may use, for example, a commercially available, porous sheet material as the porous layer. Alternatively one may prepare the porous layer using techniques generally known in the art for the preparation of microporous materials. In one embodiment one may prepare a porous, non-discriminatory porous layer by curing curable components, then applying further curable components to the formed porous layer and curing such components thereby forming a gutter layer of cured polymer on the already cured porous layer.

The porous layer is preferably a porous sheet. However the porous layer is not limited to sheet form; also porous layers in tubular form can be used, e.g. hollow fibres.

One may also use a porous layer which has been subjected to a corona discharge treatment, glow discharge treatment, flame treatment, ultraviolet light irradiation treatment or the like, e.g. for the purpose of improving its wettability and/or adhesiveness. The porous layer preferably possesses pores which are as large as possible, consistent with providing a smooth surface for the gutter layer or discriminating layer.

The porous layer preferably has an average pore size of at least about 50% greater than the average pore size of the discriminating layer, more preferably at least about 100% greater, especially at least about 200% greater, particularly at least about 1,000% greater than the average pore size of the discriminating layer.

The pores passing through the porous layer typically have an average diameter of 0.001 to 10 μm, preferably 0.01 to 1 μm. The pores at the surface of the porous layer (ignoring any gutter layer present in the pores) will typically have a diameter of 0.001 to 0.1 μm, preferably 0.005 to 0.05 μm. The pore diameter may be determined by, for example, viewing the surface of the porous layer by scanning electron microscopy (“SEM”) or by cutting through the support and measuring the diameter of the pores within the porous layer, again by SEM.

The porosity at the surface of the porous layer may also be expressed as a % porosity, i.e.

$$\% porosity = 100 \% \times \frac{( \text{area of the surface which is missing due to pores} )}{( \text{total surface area} )}$$

The areas required for the above calculation may be determined by inspecting the surface of the porous layer using SEM. Thus, in a preferred embodiment, the porous layer has a % porosity >1%, more preferably >3%, especially >10% and more especially >20%.

The porosity of the porous layer may also be expressed as a CO₂ gas permeance (units are m³(STP)/m²·s·kPa). When the membrane is intended for use in gas separation the porous layer preferably has a CO₂ gas permeance of 5 to 150×10⁻⁵ m³(STP)/m²·s·kPa, more preferably of 5 to 100, most preferably of 7 to 70×10⁻⁵ m³(STP)/m²·s·kPa.

Alternatively the porosity is characterised by measuring the N₂ gas flow rate through the porous layer. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the porous layer under test. The N₂ flow rate through the porous layer at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant membrane being reduced by the porous layer.

The abovementioned % porosity and permeance refer to the porous layer used to make the membrane (i.e. before the gutter layer and/or discriminating layer has been applied thereto).

The porous layer preferably has an average thickness of 20 to 500 μm, preferably 50 to 400 μm, especially 100 to 300 μm.

One may use an ultrafiltration membrane as the porous layer, e.g. a polysulfone ultrafiltration membrane, cellulosic ultrafiltration membrane, polytetrafluoroethylene ultrafiltration membrane, polyvinylidenefluoride ultrafiltration membrane and especially polyacrylonitrile ultrafiltration membrane. Asymmetric ultrafiltration membranes may be used, including those comprising a porous polymer membrane (preferably of thickness 10 to 150 μm, more preferably 20 to 100 μm) and optionally a woven or non-woven fabric support. The porous layer is preferably as thin as possible, provided it retains the desired structural strength.

The gutter layer, when present, may be formed on the porous layer by applying a curable composition (preferably a radiation-curable composition) to the porous layer and curing the curable composition. Preferably the gutter layer comprises dialkylsiloxane groups. Preferably the gutter layer is free from imide groups.

If desired, one may prevent the curable composition applied to the porous layer from permeating deeply into the porous layer by any of a number of techniques. For example, one may select a curable composition which has a sufficiently high viscosity to make such permeation unlikely. With this in mind, the curable composition used to form the optional gutter layer preferably has a viscosity of 0.1 to 500 Pa·s at 25° C., more preferably 0.1 to 100 Pa·s at 25° C.

The curable composition used to form the gutter layer preferably comprises a photoinitiator and a partially crosslinked, radiation-curable polymer comprising epoxy groups and siloxane groups. In this specification the partially crosslinked, radiation-curable polymer comprising epoxy groups and siloxane groups is often abbreviated in this specification to “the PCP Polymer”. Optionally the PCP Polymer is substantially free from mono-epoxy compounds (i.e. compounds which have only one epoxy group).

One may prepare the PCP Polymer by a process comprising partially curing a composition comprising one or more curable components (e.g. monomers, oligomers and/or polymers), at least one of which comprises one or more epoxy groups. Preferably the partial cure is performed by a thermally initiated polymerisation process.

In a preferred embodiment, at least one of the curable components used to form the gutter layer comprises a group which is both thermally curable and radiation-curable. This is because one may then use a thermally-initiated process for preparing the PCP Polymer and subsequently use a radiation-initiated process for forming the gutter layer. Alternatively, the thermally curable group and the radiation-curable groups are different groups and are part of the same component used to from the PCP Polymer. As thermal curing is a relatively slow process, one may partially cure the curable components thermally to form the PCP Polymer, then stop or slow down the thermal cure process, then apply a composition containing the PCP Polymer to the porous layer in the form of a composition comprising an inert solvent, and then irradiate the composition on the porous layer to form a gutter layer on the porous layer and thereby provide a gas-permeable support. The thermal cure process may be stopped or slowed down simply by cooling (e.g. to below 30° C.) and/or diluting the composition used to make the PCP Polymer at an appropriate time.

The use of two distinct mechanisms for preparing the PCP Polymer and for the final curing after the PCP Polymer has been applied to the porous layer makes the process for preparing the support more flexible and suitable for large scale production.

Groups which are curable both thermally and by irradiation include epoxy groups and ethylenically unsaturated groups such as (meth)acrylic groups, e.g. (meth)acrylate groups and (meth)acrylamide groups.

Typically the components used to form the PCP Polymer are selected such that they are reactive with each other. For example, a component having an epoxy group is reactive with a component comprising, for example, an amine, alkoxide, thiol or carboxylic acid group. One or more of the components used to form the PCP Polymer may also have more than one curable group. Components having an ethylenically unsaturated group may be reacted with other components by a free radical mechanism or, alternatively, with a nucleophilic component having for example one or more thiol or amine groups.

The radiation-curable composition used to prepare the optional gutter layer preferably comprises:
(1) 0.5 to 50 wt % of PCP Polymer;
(2) 0.01 to 5 wt % of a photo acid generator (PAG); and
(3) 50 to 99.5 wt % of inert solvent.

In order for the PCP Polymer to be radiation-curable, it preferably has at least at least two epoxy groups. Epoxy groups are preferred because their cure is usually not inhibited by presence of oxygen. The PCP polymers often have a high affinity for oxygen and this oxygen can sometimes inhibit the curing of other curable groups.

The PCP Polymer optionally comprises further radiation-curable groups, in addition to the at least two epoxy groups. Such further radiation-curable groups include ethylenically unsaturated groups (e.g. (meth)acrylic groups (e.g. CH₂═CR—C(O)— groups), especially (meth)acrylate groups (e.g. CH₂═CR—C(O)O— groups) and/or (meth)acrylamide groups (e.g. CH₂═CR—C(O)NR— groups), wherein each R independently is H or CH₃). The preferred ethylenically unsaturated groups are acrylate groups because of their fast polymerisation rates, especially when the components used to form the gutter layer are cured by irradiation with UV light. Many compounds having acrylate groups are also easily available from commercial sources.

The PAG may be ionic or non-ionic. For ionic PAGs comprising an anion and a cation, the anion is preferably tetrakis(pentafluorophenyl)borate, hexafluorophosphate, hexaflurorantimonate, or trifluoromethanesulfonate.

For ionic PAGs comprising an anion and a cation, the cation preferably comprises a sulphonium group. As an example of suitable PAGs there may be mentioned (4-phenylthiophenyl)diphenylsulfonium triflate; triphenylsulfonium triflate; Irgacure(®) 270 (available from BASF); triarylsulfonium hexafluoroantimonate; triarylsulfonium hexafluorophosphate.

Other commercially available photo-initiators may be used and optionally such photo-initiators comprise mono-epoxy compounds comprising a C-₁₀₋₁₆-alkyl group. The mono-epoxy compounds are sometimes included in the photo-initiators to act as a reactive diluent. By substantially removing such mono-epoxy compounds from the photo-initiator, or by using photo-initiators which are free from such mono-epoxy compounds, the CO₂/CH₄ selectivity of the membranes derived from PCP Polymers can often be increased.

Preferably the photo-initiator is a type I and/or type II photo-initiator.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto.

For curable compositions comprising a PCP Polymer comprising one or more acrylate group, type I photo-initiators are preferred. Especially alpha-hydroxyalkylphenones, such as 2-hydroxy-2-methyl-1-phenyl propan-1-one, 2-hydroxy-2-methyl-1-(4-tert-butyl-) phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoyl-phenylphosphinate and bis(2,4,6-trimethylbenzoyl)-phenylphosphine oxide, are preferred.

Preferably the composition used to form the GL comprises a cationic photo-initiator because the PCP Polymer comprises curable groups such as epoxy-modified groups may further comprise other curable groups such as oxetane, other ring-opening heterocyclic groups or vinyl ether groups.

Preferred cationic photo-initiators include organic salts of non-nucleophilic anions, e.g. hexafluoroarsinate anion, antimony (V) hexafluoride anion, phosphorus hexafluoride anion, tetrafluoroborate anion and tetrakis (2,3,4,5,6-pentafluorophenyl)boranuide anion.

If it is desired that the photo-initiator is substantially free from mono-epoxy compounds, one may select a commercially available photo-initiator which is free from such compounds, or one may remove such compounds from a commercially available photo-initiator which contains such compounds.

Examples of commercially available photo-initiators which are free from mono-epoxy compounds include, for example, hexafluoroantimonate salts, pentafluorohydroxyantimonate salts, hexafluorophosphate salts and hexafluoroarsenate salts. Among these photo-initiators, sulphonium salts and iodonium salts are preferably used. The PAG may be used in addition to such a photoinitiator or in place of such a photoinitiator.

Examples of suitable sulphonium salts include triphenylsulphonium hexafluorophosphate, triphenylsulphonium hexafluoroantimonate, triphenylsulphonium tetrakis(pentafluorophenyl)borate, 4,4′-bis[diphenylsulphonio]diphenylsulfide bishexafluorophosphate, 4,4′-bis[di(beta-hydroxyethoxy)phenylsulphonio]diphenylsulfide bishexafluoroantimonate, 4,4′-bis[di(beta-hydroxyethoxy)phenylsulphonio]diphenylsulfide bishexafluorophosphate, 7-[di(p-toluyl)sulphonio]-2-isopropylthioxanthone hexafluoroantimonate, 7-[di(p-toluyl)sulphonio]-2-isopropylthioxanthone tetrakis(pentafluorophenyl)borate, 4-phenylcarbonyl-4′-diphenylsulphonio-diphenylsulphide hexafluorophosphate, 4-(p-tert-butylphenylcarbonyI)-4′-diphenylsulphonio-diphenylsulphide hexafluoroantimonate, and 4-(p-tert-butylphenylcarbonyl)-4′-di(p-toluyl)sulphonio-diphenylsulphide tetrakis(pentafluorophenyl)borate (e.g. DTS-102, DTS-103, NDS-103, TPS-103 and MDS-103 from Midori Chemical Co. Ltd.).

Examples of suitable iodonium salts include phenyliodonium hexafluoroantimonate (e.g. CD-1012 from Sartomer Corp.), diphenyliodonium tetrakis(pentafluorophenyl)borate, diphenyliodonium hexafluorophosphate, diphenyliodonium hexafluoroantimonate, bis(dodecylphenyl)iodonium hexafluoroantimonate, and di(4-nonylphenyl)iodonium hexafluorophosphate. MPI-103, BBI-103 from Midori Chemical Co. Ltd. may also be used, as may certain iron salts (e.g. Irgacure™ 261 from Ciba).

Preferred commercially available photo-initiators free from epoxy compounds include 4-isopropyl-4′-methyldiphenyliodonium tetrakis(pentafluorophenyl) borate ((C₄₀H₁₈BF₂₀l)) available under the name l0591 from TCI) and 4-(octyloxy)phenyl](phenyl) iodonium hexafluoroantimonate (C₂ₒH₂₆F₆IOSb, available as AB153366 from ABCR GmbH Co).

The radiation-curable composition used to form the gutter layer (when present) may contain other components, for example surfactants, surface tension modifiers, viscosity enhancing agents, biocides, other components capable of co-polymerisation with the PCP Polymer or other ingredients.

The radiation-curable composition used to form the optional gutter layer may be applied to the porous layer by any suitable coating technique, for example by curtain coating, meniscus type dip coating, kiss coating, pre-metered slot die coating, reverse or forward kiss gravure coating, multi roll gravure coating, spin coating and/or slide bead coating.

Conveniently the composition used to form the optional gutter layer may be coated onto the porous layer by a multilayer coating method, for example using a consecutive multilayer coating method.

In a preferred consecutive multilayer process a layer of the curable composition used to form the optional gutter layer, a layer of the radiation-curable composition used to form the discriminating layer and optionally a protective layer are applied consecutively to the porous layer, with the curable composition used to form the optional gutter layer being applied before the layer of the composition used to form the discriminating layer.

In order to produce a sufficiently flowable composition for use in a high speed coating machine, the curable composition used to form the optional gutter layer and the composition used to form the discriminating layer preferably have a viscosity below 4000 mPa s when measured at 25° C., more preferably from 0.4 to 1000 mPa·s when measured at 25° C. Most preferably the viscosity is from 0.4 to 500 mPa·s when measured at 25° C. For coating methods such as slide bead coating the preferred viscosity is from 1 to 100mPa·s when measured at 25° C. The desired viscosity is preferably achieved by controlling the amount of solvent in the composition and/or the conditions for preparing the components thereof.

In the multi-layer coating methods mentioned above one may optionally apply a lower inert solvent layer to the porous layer followed by applying the curable composition used to provide the gutter layer.

With suitable coating techniques, coating speeds of at least 5m/min, e.g. at least 10m/min or even higher, such as 15m/min, 20m/min, or even up to 100m/min, can be reached. In a preferred embodiment the curable composition(s) are applied to the porous layer/support at one of the aforementioned coating speeds.

The thickness of the optional gutter layer and protective layer on top of the discriminating layer may be influenced by controlling the amount of curable composition per unit area applied to the support or discriminating layer, as the case may be. For example, as the amount of curable composition per unit area increases, so does the thickness of the resultant gutter layer. The same principle applies to formation of the discriminating layer and the optional protective layer.

While it is possible to practice the invention on a batch basis with a stationary support, to gain full advantage of the invention it is much preferred to perform the process on a continuous basis using a moving support, e.g. the support may be in the form of a roll which is unwound continuously or the support may rest on a continuously driven belt. Using such techniques the curable composition(s) can be applied to the support on a continuous basis or it/they can be applied on a large batch basis. Removal of the inert solvent from the curable composition(s) can be accomplished at any stage after the composition(s) have been applied to the support, e.g. by evaporation.

Thus a preferred process for preparing a membrane according to the present invention comprising a GL and DL comprises;

applying a radiation-curable composition continuously to a porous layer by means of a manufacturing unit comprising a GL application station and curing that composition to form a GL on the porous layer,

applying a composition comprising a polyimide to the GL by means of a manufacturing unit comprising a DL application station and irradiating the composition with a UV-C light to form a membrane comprising a DL and a GL, and

collecting the resultant membrane at a collecting station, wherein the manufacturing unit comprises a means for moving the porous layer from the GL application station to an irradiation source and to the DL application station and the UV-C light source and to the membrane collecting station and wherein the composition comprising a polyimide is irradiated using UV-C light and irradiation as described above in relation to the first aspect of the present invention.

If desired the DL may be applied to the GL using a different manufacturing unit from that used to apply the GL to the porous layer. Thus one may prepare a support comprising a GL, store the support, then apply the composition comprising a polyimide to the support later either using the same manufacturing unit used to apply the GL to the porous layer or using a different manufacturing unit.

The gutter layer usually has the function of providing a smooth and continuous surface for the discriminating layer. While it is preferred for the gutter layer to be pore-free, the presence of some pores usually does not reduce the permselectivity of the final membrane because the discriminating layer is often able to fill minor defects in the gutter layer.

The gutter layer (when present) preferably has a thickness of 25 to 800 nm, preferably 100 to 750 nm, especially 200 to 700 nm, e.g. 300 to 650 nm, or 400 to 600 nm, or 450 to 550 nm. The thickness of the gutter layer may be determined by cutting through the layer and examining its cross section using a scanning electron microscope. “Thickness” refers to the part of the gutter layer which is present on top of the porous layer and is an average value. The part of the curable composition used to form the gutter layer which is present within the pores of the porous layer is not taken into account.

The gutter layer is preferably essentially nonporous, i.e. any pores present therein have an average diameter <1 nm. This does not exclude the presence of defects which may be significantly larger. Defects may be corrected by the discriminating layer as described above.

The irradiation step which may be used to form the GL may be performed using any source which provides the wavelength and intensity of radiation necessary to cause the radiation-curable composition used to for, the GL to polymerise. For example, electron beam, UV, visible and/or infra red radiation may be used to cure the composition, the appropriate radiation being selected to match the composition.

Preferably irradiation of the composition comprising a polyimide begins within 7 seconds, more preferably within 5 seconds, most preferably within 3 seconds, of that composition being applied to the support.

Preferably the UV-C light source emits light of higher intensity in the aforementioned range than in the range 100 to 199 nm or 281 to 315 nm.

Preferably the composition comprising a polyimide is irradiated with the specified UV light for a period of time in the range 0.1 to 30 seconds, more preferably 0.5 to 20 seconds, especially 0.75 to 15 seconds.

Suitable UV-C light sources include mercury arc lamps, carbon arc lamps, low pressure mercury lamps, medium pressure mercury lamps, high pressure mercury lamps, metal halide lamps, tungsten lamps, halogen lamps, lasers and ultraviolet light emitting diodes. Particularly preferred are ultraviolet light emitting lamps of the medium or high pressure mercury vapour type. In addition, additives such as metal halides may be present to modify the emission spectrum of the lamp. Preferably the UV-C light source comprises a mercury vapour bulb, for example a H-bulb. Mercury vapour bulbs are available from a number of sources such as Miltec (H-bulb) and Heraeus (H-bulb). A mercury arc lamp is particularly effective as the UV-C light source, but light emitting diodes which emit light having a wavelength in the range 200 to 280 nm can also be used. However to achieve the benefits of the present invention the radiation source must apply UV-C light having the wavelength and properties described above in the first aspect of the present invention.

Preferably the composition comprising a polyimide is irradiated with the UV light at a power intensity of 100 to 250 mW/cm², more preferably 40 to 200 mW/cm². These power ranges help to provide membranes rapidly which have good selectivity, good flux and have a low tendency to crack Thus the power intensity is number of mW of UV light of the specified wavelength applied per cm² of composition. The power intensity may be controlled by adjusting the power applied to the source of the UV light and/or by adjusting the distance between the UV light and the composition being cured. Preferably the UV light is provided by a UV POWER PUCK® II radiometer, available from EIT Instrument Markets. The discriminating layer preferably has pores of average diameter below 2 nm, preferably below 1 nm, and preferably the discriminating layer is substantially non-porous. Preferably the discriminating layer has a very low permeability to liquids.

The discriminating layer preferably has a dry thickness of 10 to 300 nm, more preferably 10 to 150 nm, especially 20 to 100 nm. The dry thickness may be determined by cutting through the dry membrane and measuring the thickness of the discriminating layer above the gutter layer (in case a gutter layer is sued) using a scanning electron microscope.

The composition comprising a polyimide used to make the discriminating layer preferably comprises a polyimide, an inert solvent and optionally an initiator.

The inert solvent may be any solvent capable of dissolving the polymer used to form the discriminating layer. Suitability of the solvent is determined by the properties of the polymer and the concentration desired. Suitable solvents include water, C₅₋₁₀-alkanes, e.g. cyclohexane, heptane and/or octane; alkylbenzenes, e.g. toluene, xylene and/or C₁₀-C₁₆ alkylbenzenes; C₁₋₆-alkanols, e.g. methanol, ethanol, n-propanol, isopropanol, n-butanol, sec-butanol, tert-butanol, n-pentanol, cyclopentanol and/or cyclohexanol; linear amides, e.g. dimethylformamide or dimethylacetamide; ketones and ketone-alcohols, e.g. acetone, methyl ether ketone, methyl isobutyl ketone, cyclohexanone and/or diacetone alcohol; ethers, e.g. tetrahydrofuran and/or dioxane; diols, preferably diols having from 2 to 12 carbon atoms, e.g. pentane-1,5-diol, ethylene glycol, propylene glycol, butylene glycol, pentylene glycol, hexylene glycol and/or thiodiglycol; oligo- and poly-alkyleneglycols, e.g. diethylene glycol, triethylene glycol, polyethylene glycol and/or polypropylene glycol; triols, e.g. glycerol and/or 1,2,6-hexanetriol; mono-C₁₋₄-alkyl ethers of diols, preferably mono-C₁₋₄-alkyl ethers of diols having 2 to 12 carbon atoms, e.g. 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and/or ethyleneglycol monoallylether; cyclic amides, e.g. 2-pyrrolidone, N-methyl-2-pyrrolidone, N-ethyl-2-pyrrolidone, caprolactam and/or 1,3-dimethylimidazolidone; cyclic esters, e.g. caprolactone; sulphoxides, e.g. dimethyl sulphoxide and/or sulpholane; and mixtures comprising two or more of the foregoing.

The discriminating layer is generally polymeric in nature.

Preferably the polyimide comprises optionally substituted 1,3-phenylene groups, more preferably optionally substituted 2,4,6-trimethyl-1,3-phenylene groups, especially 2,4,6-trimethyl-1,3-phenylene groups, having an atom or substituent other than H at the 5-position. Examples of atoms and substituents other than H which may be present at the 5-position include sulfamoyl, sulphinic, sulphonic, alkoxysulfonyl, carboxy, amide, thiol, hydroxy, acyloxy and halogen. Preferably the polyimide comprises a repeat unit of the Formula (I):

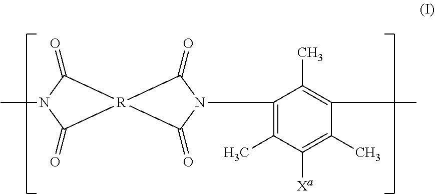

wherein:
each X^{a} independently is H, sulfamoyl, alkoxysulfonyl, carboxy, hydroxy, amide, sulphinic, sulphonic, thiol, acyloxy or halogen;
   and
each R independently is a tetravalent linking group.

Preferably the tetravalent linking group represented by R is an organic tetravalent linking group, e.g. having one of the following Formulae (I-1) to (I-28):

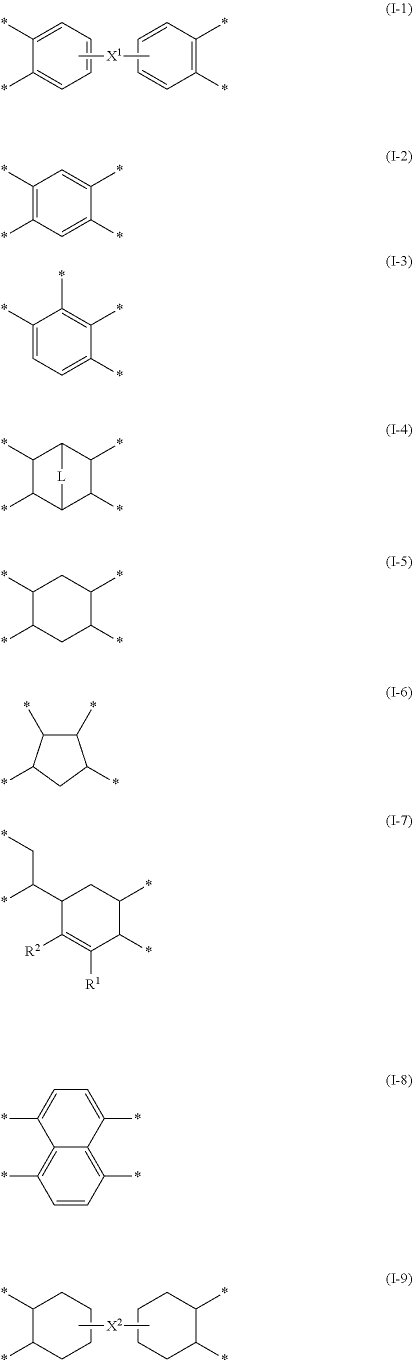

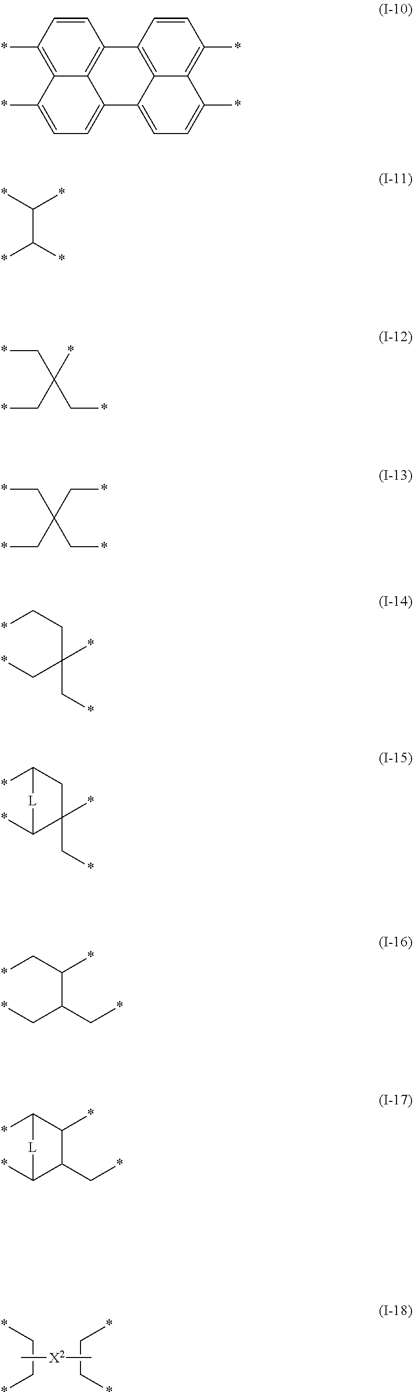

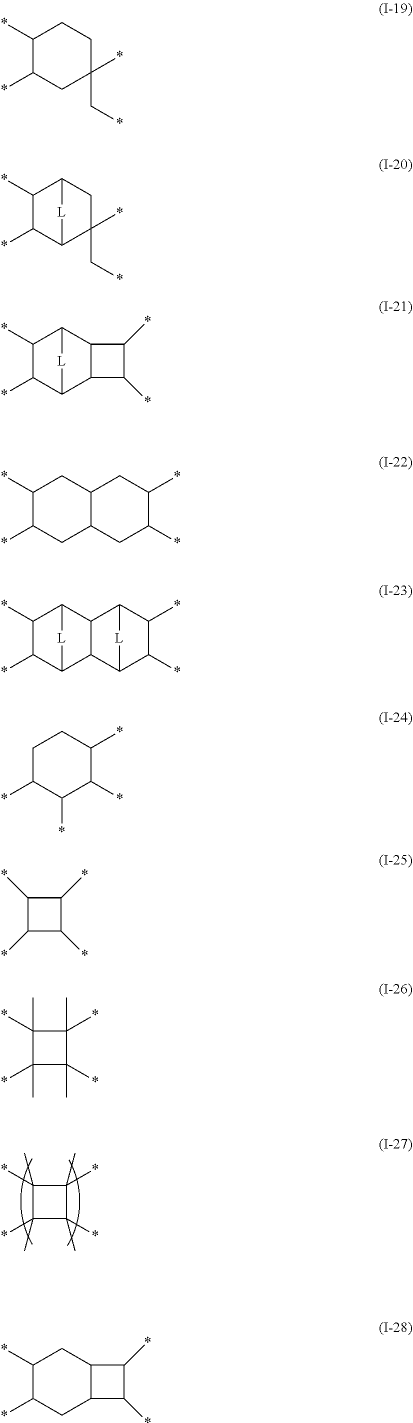

wherein:
each X¹, X² and X³ independently is a single bond or a divalent linking group;
each L independently is —CH═CH—, —CH₂CH₂— or —CH₂—; and
each R¹ and R² independently is H, alkyl (e.g. C₁₋₄-alkyl, especially methyl) or halogen (especially F, Cl or Br); and the symbols “*” represents a binding site with respect to a carbonyl groups shown in Formula (I) above. Preferred sulfamoyl groups are of the formula —SO₂NR₃R₄, preferred alkoxysulfonyl are of the formula —S(═O)OR₅), preferred carboxy groups are of the formula —CO₂H or a salt thereof, preferred amide groups are of the formula —CONR₃R₄ or —NR₃COR₄, thiol groups are of the formula —SH, hydroxy groups are of the formula —OH, preferred acyloxy groups are of the formula —CO₂R₅ and preferred halogen groups are of the formula F, Cl or Br, wherein each R₃ and each R₄ independently is H or C₁₋₄-alkyl and each R₅ independently is C₁₋₄-alkyl. Preferred sulphinic and sulphonic groups are of the formula —SO₂H and —SO₃H respectively, including salts thereof. Preferably X^{a} is a —SO₂NH₂—, —SO₂NHCH₃ or —SO₂NHCF₃ group.

The divalent linking groups represented by X¹, X², X³ are preferably each independently organic divalent linking groups, more preferably optionally substituted alkylene groups, especially optionally substituted C₁₋₄-alkylene groups. The optional substituents are preferably electron withdrawing groups, e.g. one or more —CF₃ groups. In a particularly preferred embodiment X¹, X², X³ are bis(trifluormethyl)methylene groups, i.e. of the formula —C(CF₃)₂—.

Preferably the tetravalent linking group is of the Formula (II -1) or, more preferably of the Formula (II-2), wherein the symbols “*” represents a binding site with respect to a carbonyl groups shown in Formula (I) above:

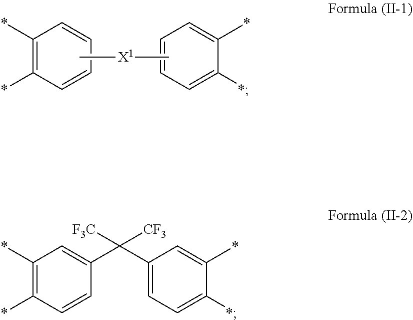

wherein X¹ is as defined above.

Preferred polyimides comprising trifluoromethyl groups.

A particularly preferred polyimide comprises groups of the Formula (III):

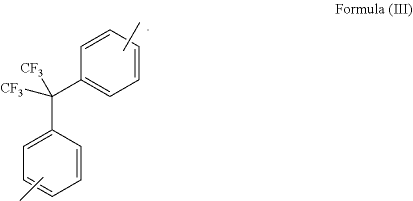

Polyimides comprising trifluoromethyl groups may be prepared by, for example, the general methods described in U.S. Pat. Reissue No. 30,351 (based on U.S. Pat. No. 3,899,309) U.S. Pat. No. 4,717,394 and U.S. Pat. No. 5,085,676.

More preferably the polyimide comprising groups of the Formula (IV):

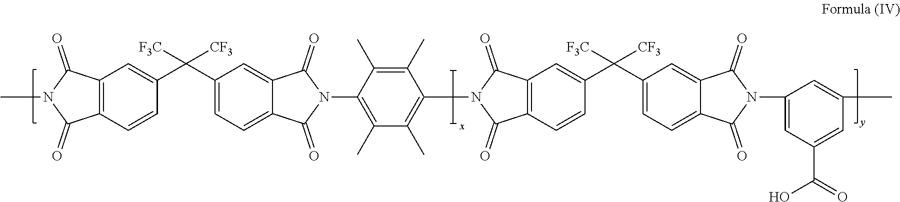

wherein the number ratio of x:y is from 10:90 to 99:1, more preferably 15:85 to 95:5, especially 20:80 to 90:10.

In one embodiment the composition comprising a polyimide is curable, e.g. radiation-curable. The composition used to prepare the discriminating layer preferably comprises a photo-initiator. The photoinitiator may be selected from those described above for the gutter layer provided that the photo initiator strongly absorbs the wavelength of light emitted by the UV-C source(e.g. in the range 200 to 280 nm).

Preferably the discriminating layer is obtained from a composition which is free from mono-epoxy compounds comprising a C-₁₀₋₁₆-alkyl group, more preferably free from epoxy compounds having a molecular weight below 300 or 400 Daltons.

The discriminating layer may be applied to the support by any suitable technique, for example a phase inversion technique or, for example, by a process comprising any of the coating methods described above in relation to application of the optional gutter layer to the porous layer.

For improving the adhesion of the discriminating layer to the gutter layer (when presnt) the latter may be treated by a corona discharge or plasma treatment before forming the discriminating layer thereon. For the corona or plasma treatment generally an energy dose of 0.5 to 100 kJ/m² will be sufficient.

The optional protective layer may be formed on the discriminating layer by any suitable technique, for example by a process comprising any of the coating methods described above in relation to application of the optional gutter layer.

The protective layer, when present, preferably is highly permeable to the gases or vapours that are to be separated. Preferably the protective layer comprises dialkylsiloxane groups.

Preferably the average thickness of the PL is between 300 and 1500 nm, more preferably between 500 and 1300 and especially between 600 and 1200 nm.

The curable composition used to prepare the optional protective layer may be any curable composition, although a curable composition as independently described above for preparation of the gutter layer is preferred. Thus the curable composition used to form the PL may be the same as or different to the curable composition used to form the GL. The protective layer optionally has surface characteristics which influence the functioning of the membrane, for example by making the membrane surface more hydrophilic or hydrophobic.

The membrane preferably has a water permeability at 20° C. of less than 6.10⁻⁸ m³/m²·s·kPa, more preferably less than 3.10⁻⁸ m³/m²·s·kPa.

The overall dry thickness of the membrane is preferebly 20 to 500 μm, more preferably from 30 to 300 μm.

In one embodiment the process comprises the steps:
a) applying the composition used to form the GL to the porous layer and curing that composition to provide a gas-permeable support comprising a GL;
b) applying the composition comprising a polyimide to the GL and curing that composition to provide a membrane; and
c) optionally applying the composition used to form the PL to the membrane and curing that composition to provide a membrane comprising a PL.

In a preferred embodiment the processes of the present invention are continuous processes.

In a preferred embodiment, the application referred to in step a) is performed by meniscus type dip coating. Preferably the applications referred to in steps b) and c) are each independently performed by reverse kiss gravure coating, meniscus type dip coating, pre-metered slot die coating or spin coating.

For production on a small scale, it is convenient to perform steps b) and c) by the same process.

Three-roll offset gravure coating may also be used for step b) and/or c), especially when the compositions used in these steps have a high viscosity.

The processes of the present invention may contain further steps if desired, for example washing and/or drying or partially drying one or more of the various layers and/or the resultant membrane.

According to a second aspect of the present invention there is provided a membrane, especially a gas-permeable membrane, obtainable or obtained by a process according to the first aspect of the present invention.

A preferred membrane according to the second present invention comprises:
i) a gas-permeable support;
ii) a discriminating layer comprising polyimide groups; and
iii) optionally a protective layer.

A third aspect of the present invention provides a gas separation cartridge comprising a membrane according to the second aspect of the present invention.

A fourth aspect of the present invention provides the use of a membrane according to the second aspect of the present invention and/or a gas separation cartridge according to the third aspect of the present invention for the separation or purification of gases or vapours. For example, one may use the membrane and/or cartridge to separate a feed gas containing a target gas into a gas stream rich in the target gas and a gas stream depleted in the target gas.

A fifth aspect of the present invention provides a gas separation module comprising a housing and one or more cartridges according to the third aspect of the present invention.

The membranes of the present invention are preferably in tubular form or, more preferably, in sheet form. Tubular forms of membrane are sometimes referred to as being of the hollow fibre type. Membranes in sheet form are suitable for use in, for example, spiral-wound, plate-and-frame and envelope cartridges.

The membranes of the present invention are particularly suitable for separating a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the membranes have a high permeability to polar gases, e.g. CO₂, H₂S, NH₃, SO_{X}, and nitrogen oxides, especially NOₓ, relative to non-polar gases, e.g. alkanes (e.g. CH₄), H₂, and N₂.

The target gas may be, for example, a gas which has value to the user of the membrane and which the user wishes to collect. Alternatively the target gas may be an undesirable gas, e.g. a pollutant or a ‘greenhouse gas’, which the user wishes to separate from a gas stream in order to protect the environment.

The membranes of the present invention are particularly useful for purifying natural gas (a mixture which comprises methane) by removing polar gases (CO₂, H₂S); for purifying synthesis gas; and for removing CO₂ from hydrogen and from flue gases. Flue gases typically arise from fireplaces, ovens, furnaces, boilers, combustion engines and power plants. The composition of flue gases depend on what is being burned, but usually they contain mostly nitrogen (typically more than two-thirds) derived from air, carbon dioxide (CO₂) derived from combustion and water vapour as well as oxygen. Flue gases also contain a small percentage of pollutants such as particulate matter, carbon monoxide, nitrogen oxides and sulphur oxides. Recently the separation and capture of CO₂ has attracted attention in relation to environmental issues (global warming).

The membranes of the present invention are particularly useful for separating the following, especially at high pressures, e.g. of 20 bar or more:

a feed gas comprising CO₂ and N₂ into a gas stream richer in CO₂ than the feed gas and a gas stream poorer in CO₂ than the feed gas; a feed gas comprising CO₂ and CH₄ into a gas stream richer in CO₂ than the feed gas and a gas stream poorer in CO₂ than the feed gas; and
a feed gas comprising CO₂ and H₂ into a gas stream richer in CO₂ than the feed gas and a gas stream poorer in CO₂ than the feed gas, a feed gas comprising H₂S and CH₄ into a gas stream richer in H₂S than the feed gas and a gas stream poorer in H₂S than the feed gas; and a feed gas comprising H₂S and H₂ into a gas stream richer in H₂S than the feed gas and a gas stream poorer in H₂S than the feed gas.

It is notable that the membranes of the present invention provide good selectivity even when the gases they are exposed to are ‘dirty’, e.g. by being contaminated with hydrocarbons containing two or more carbon atoms (e.g. ethane, propane, n-butane, n-heptane and/or toluene)

Preferably the membrane of the present invention has a CO₂/CH₄ selectivity (αCO₂/CH₄)>20. Preferably the selectivity is determined by a process comprising exposing the membrane to a 13:87 mixture by volume of CO₂ and CH₄ at a feed pressure of 6000 kPa and a temperature of 40° C.

Preferably the membrane of the present invention has a CO₂/N₂ selectivity (αCO₂/N₂)>35. Preferably the selectivity is determined by a process comprising exposing the membrane to CO₂ and N₂ separately at feed pressures of 6000 kPa and a temperature of 40° C. The CO₂/N₂ selectivity (αCO₂/N₂) and CO₂/CH₄ selectivity (αCO₂/CH₄) may be measured for both clean gas and dirty gas, as illustrated in the Examples. The preferred selectivities described above apply to both clean gases and dirty gases.

While this specification emphasises the usefulness of the membranes of the present invention for separating gases, especially polar and non-polar gases, it will be understood that the membranes can also be used for other purposes, for example providing a reducing gas for the direct reduction of iron ore in the steel production industry, dehydration of organic solvents (e.g. ethanol dehydration), pervaporation and vapour separation and also for breathable apparel.

The membranes of the present invention are particularly useful for preparing gas separation modules comprising the membranes in spiral-wound form because the membranes of the present invention have a low tendency to crack, even when exposed to high gas pressures, as illustrated in the Examples below. The invention will now be illustrated by the following non-limiting Examples in which all parts and percentages are by weight unless otherwise specified. (“Ex” means Example and “CEx” means Comparative Example).

The following materials were used in the Examples and/or Comparative Examples below:
PI1 is 6FDA-TeMPD x /DABA y, x/y=20/80; obtained from FUJIFILM Finechemicals Co., Ltd, having the following structure:

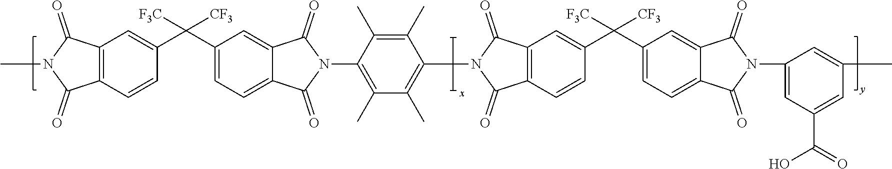

PI2 is 6FDA-TeMPD x /DABA y, x/y=90/10; obtained from FUJIFILM

Finechemicals Co., Ltd, having the general structure shown above for P11 except that the ratio of x/y is 90/10 instead of 20/80.
GMT is a porous support polyacrylonitrile L14 ultrafiltration membrane from GMT Membrantechnik GmbH, Germany.
UV-9300 is SilForce™ UV9300 from Momentive Performance Materials Holdings. This is thermally curable copolymer comprising at least 3 epoxy groups and linear polydimethyl siloxane chains. Furthermore, this copolymer cures rapidly when irradiated with UV light in the presence of a photo-initiator.
MEK is 2-butanone from Brenntag Nederland BV.
X-22-162C is a dual end reactive silicone having carboxylic acid reactive groups, a viscosity of 220 mm²/s and a reactive group equivalent weight of 2,300 g/mol] from Shin-Etsu Chemical Co., Ltd. (MWT 4,600).
l0591 is 4-isopropyl-4′-methyldiphenyliodonium tetrakis(pentafluorophenyl) borate (C₄ₒH₁₈BF₂₀l) from TCl.
Tyzor TPT is titanium (IV) isopropoxide (linear formula Ti[OCH(CH₃)₂]₄); molecular weight: 284.22; and CAS Number: 546-68-9.
APTMS is (3-Aminopropyl)trimethoxysilane from Sigma Aldrich.
MIBK is methy isobuyl ketone from Brenntag Nederland BV.
BuOH is n-butanol from Brenntag Nederland BV.
PP is a non-woven 100 μm sheet FO23223-10 from Freudenberg.
DIOX is 1,3-dioxolane from Brenntag Nederland BV.
Blue Dye is 1,4-bis[(2-ethylhexyl)amino]-anthraquinone.

The Clean Gas and Dirty Gas had the compositions shown in Table 1 below:

TABLE 1

| | Gas composition vol % | | | | | | |
|---|---|---|---|---|---|---|---|
| | CO₂ | CH₄ | C₂H₆ | C₃H₈ | n- C₄H₈ | n-C₇H1₆ | Toluene |
| Dirty Gas | 9.00 | 82.12 | 4.50 | 3.00 | 1.00 | 0.30 | 0.08 |
| Clean Gas | 9.00 | 91.00 | 0.00 | 0.00 | 0.00 | 0.00 | 0.00 |

### Evaluation of Gas Flux, Selectivity, Viscosity and Cracking Performance

The gas flux, selectivity, viscosity and cracking performance of the membranes were determined as follows:

### (A) Gas Flux

The Clean Gas and Dirty Gas mixtures (as defined in Table 1 above) were applied independently to each membrane under test at 40° C. at a gas feed pressure of 6000 kPa. The flux of CO₂ and CH₄ through each membrane was measured for each gas mixture using a gas permeation cell with a measurement diameter of 3.0 cm.

The flux of CO₂ and CH₄ through a membrane under test was determined for each mixture (i.e. Clean Gas and Dirty Gas) after a period of 5 minutes continuous use using the following equation:

Qᵢ=(θ_{Perm}·X_{Perm,i})/(A·(P_{Feed}·X_{Feed,l}−P_{Perm}·X_{Perm,i}))

wherein:

Qᵢ=Flux of the relevant gas (i.e. CO₂ or CH₄) (m³(STP)/m²·kPa·s);

θ_{Perm}=Permeate flow rate (m³(STP)/s);

X_{perm,i}=Volume fraction of the relevant gas in the permeate gas;

A =Membrane area (m²);

P_{Feed}=Feed gas pressure (kPa);

X_{Feed,i}=Volume fraction of the relevant gas in the feed gas;

Pₚₑᵣₘ=Permeate gas pressure (kPa); and

STP is standard temperature and pressure, which is defined here as 25.0° C. and 1 atmosphere pressure (101.325 kPa).

### (B) Selectivity

The CO₂/CH₄ selectivity (α_{CO2/CH4}) of each membrane under test for the Clean Gas and Dirty Gas mixtures described in Table 1 was calculated from Q_{CO2} and Q_{CH4} calculated above, based on following equation:

α_{CO2/CH4}=Q_{CO2}/Q_{CH4}

In these experiments selectivity values of 15 or higher were deemed to be acceptable. Selectivity values below 15 were deemed to be unacceptable.

### (C) Evaluation of Viscosity

Viscosity was measured using a Brookfield LVDV-II+PCP viscosity meter, using either spindle CPE-40 or CPE-52 depending on viscosity range.

### (D) Cracking Performance

The extent to which the membranes under test cracked when subjected to high pressures was determined as follows:

### (D1)—Applying Pressure to The Membrane and Spacer Pack in a Cell

The membrane under test was cut into round pieces with diameter of 48 mm. A vertical stack of 1 membrane under test and a permeate spacer (diameter 47 mm) of Guilford G36168 was placed into a cell. A mixture of O₂/N₂ gas was applied to the stack on membrane side at a pressure of 100 bar for 30 minutes at 60° C. The pressure was then reduced to atmospheric pressure and the membranes were removed from the cell for visual assessment of the extent of cracking by step (D2) below:

(D2)—Assessing the Extent of Cracking Cracks in the membrane which has been subjected to high pressures as described in Step (D1) were visualized by dyeing method with a 1 wt % solution of 1,4-bis[(2-ethylhexyl)amino]-anthraquinone in n-heptane. 6 drops of the dye solution was applied at room temperature for 30 seconds to the entire surface of the membrane. Then the excess of dye-ing solution was removed from the membrane and the membrane surface was washed with n-heptane. Afterwards the membrane was examined visually. If blue spots on the membrane were visible to the naked eye this indicated the presence of cracks and the membrane was scored “not okay”, abbreviated to (NOK). If no blue spots were visible to the naked eye this indicated the absence of cracks and the membrane was scored “okay”, abbreviated to (OK).

### PREPARATION OF THE EXAMPLES AND COMPARATIVE EXAMPLES

### Stage a) Preparation of the PCP Polymer (A Component of the Guttter Layer)

A solution of a PCP Polymer (“PCP Polymer 1”) was prepared by heating the components described in Table 2 together for 105 hours at 95° C. The resultant solution of PCP Polymer 1 had a viscosity of about 64,300 mPas when measured at 25° C.

TABLE 2
Ingredients used to prepare PCP Polymer 1

| Ingredient | Amount (w/w %) |
|---|---|
| UV-9300 | 46.4% |
| X-22-162C | 13.6% |
| n-Heptane | 40.0% |
| Total | 100.0% |

### Stage b) Preparation of a Curable Composition Used to Form a Gutter Layer (RCC1)

Portions of the solution of PCP Polymer 1 obtained in stage a) above were cooled to 20° C., diluted with n-heptane and then filtered through a filter paper having an average pore size of 2.7 μm. The ingredients indicated in Table 3 below were added to make RCC1 as indicated in Table 3 below wherein the % are w/w % (weight/weight %).

TABLE 3

| Ingredient | RCC1 |
|---|---|
| PCP Polymer 1 | 16.67% |
| n-Heptane | 81.00% |
| MEK | 2.00% |
| Tyzor TPT | 0.22% |
| I0591 | 0.11% |
| Total | 100.0% |

Solids content of RCC1 10%

### Stage c) Preparation of Compositions Used to Form Discriminating Layers

Compositions DSL1, DSL2 and DSL3 were prepared by mixing the components shown in Table 4 (wherein the % are w/w %) and filtering the mixture through a filter paper having an average pore size of 2.7 μm.

TABLE 4

| Ingredient | DSL1 | DSL2 | DSL3 |
|---|---|---|---|
| PI1 | 1.00% | — | — |
| PI2 | — | 1.00% | 22.00% |
| MEK | 93.99% | 93.99% | 51.69% |
| DIOX | 5.0% | 5.0% | — |
| MIBK | — | — | 18.4% |
| BuOH | — | — | 7.9% |
| APTMS | 0.0100% | 0.0100% | 0.0100% |
| Total | 100% | 100% | 100% |

### Stage d) Preparation of a Composition Used to Form a Protective Layer

Composition PL1 was prepared by mixing the components shown in Table 5 (wherein the % are w/w %) and filtering the mixture through a filter paper having an average pore size of 2.7 μm.

TABLE 5

| Ingredient | PL1 |
|---|---|
| PCP polymer | 11.67% |
| n-Heptane | 86.11% |
| MEK | 2.00% |
| Tyzor TPT | 0.15% |
| I0591 | 0.07% |
| Total | 100.0% |

Stage e) Preparation of Gas-Permeable Support In Ex5 and CEx5 the gas permeable supports were commercially available PP. These gas permeable supports did not comprise a gutter layer.

In CEx1 to CEx4, Ex1 to Ex4, Ex6 and Ex7 the gas permeable supports were prepared as follows:

Composition RCC1 was applied to a porous layer in an amount of 6 mL/m² by meniscus dip coating at a speed of 10m/min. The composition RCC1 present on the porous layer was irradiated with UV light using a Light Hammer LH10 from Fusion UV Systems fitted with a H-bulb at an intensity of 16.8 kW/m (70%) which was UV-curing with an energy of 70 mJ/cm² for 0.3 seconds. The resultant gas-permeable supports each comprised a gutter layers having a dry thickness of 300 nm.

### Stage f) Applying the Discriminating Layer

The radiation curable compositions DSL1, DSL2 and DSL3 described in Table 4 above were applied to gas-permeable supports in an amount of 10 mL/m2, as indicated in Table 6 below, using meniscus type coating at a 10 m/min coating speed. The resultant, coated supports were then irradiated with UV light for 0.7 seconds using a Light Hammer LH10 from Fusion UV Systems fitted with a H-bulb. The irradiation exposed the curable compositions with the power intensities (mW/cm²) indicated in Table 6.

The PL1 was added (except for EX) and again the irradiation was done using a Light Hammer LH10 from Fusion UV Systems fitted with a H-bulb and irradiating with an intensity of 16.8 kW/m (70%) which is UV-curing with an energy of 70 mJ/cm²

### Testing

After stages a) to f) had been completed, the resultant membranes were wound onto a spool of diameter 7.6 cm at a winding tension of 100N/width and then allowed to dry and age on the spool for 2 days at room temperature. The membranes were then cut into circular patches of diameter of 47 mm and each patch was “forced” aged for 7 days at 90° C. After ageing membrane patches were placed in a cell where it was exposed for 16 hr to the Dirty Gas or 15 min to the Clean Gas defined in Table 1 at a pressure of 60 bar on one side of the membrane and atmospheric pressure on the other side of the membrane.

Cracking evaluation is described in more detail in the section “(D)

Cracking Performance” above. The membranes were then removed from the cell and examined for crack defects using the method described above in the section “(D2)—Assessing the Extent of Cracking”. The results are shown in Table 6 below.

TABLE 6

| | CEx1 | CEx2 | Ex1 | Ex2 | Ex3 | Ex4 |
|---|---|---|---|---|---|---|
| Porous Layer | GMT | GMT | GMT | GMT | GMT | GMT |
| Curable composition used to form the GL | RCC1 | RCC1 | RCC1 | RCC1 | RCC1 | RCC1 |
| Amount of curable composition applied to the porous | 6 mL/m2 | 6 mL/m2 | 6 mL/m2 | 6 mL/m2 | 6 mL/m2 | 6 mL/m2 |
| layer to form the GL | | | | | | |
| Dry thickness of the resultant GL | 600 nm | 600 nm | 600 nm | 600 nm | 600 nm | 600 nm |
| Composition used to form the DL | DSL1 | DSL2 | DSL1 | DSL2 | DSL1 | DSL2 |
| Amount of composition applied to the GL to form the DL | 10 mL/m² | 10 mL/m² | 10 mL/m² | 10 mL/m² | 10 mL/m² | 10 mL/m² |
| Dry thickness of the resultant DL | 100 nm | 100 nm | 100 nm | 100 nm | 100 nm | 100 nm |
| Curable composition used to form the PL | PL1 | PL1 | PL1 | PL1 | PL1 | PL1 |
| Amount of composition applied to the DL to form the PL | 9 mL/m² | 9 mL/m² | 9 mL/m² | 9 mL/m² | 9 mL/m² | 9 mL/m² |
| Dry thickness of the resultant PL | 595 nm | 595 nm | 595 nm | 595 nm | 595 nm | 595 nm |
| UV exposure time for the DL (seconds) | 0.7 | 0.7 | 0.7 | 0.7 | 0.7 | 0.7 |
| Power intensity of UV light used to cure the DL (mW/cm²) | 15 | 15 | 45 | 45 | 135 | 135 |
| CO2 flux (GPU) in clean gas | 40 | 97 | 21 | 45 | 20 | 43 |
| CO2/CH4 selectivity in clean gas | 20 | 15 | 33 | 23 | 35 | 25 |
| CO2 flux (GPU) in dirty gas | 65 | 135 | 25 | 65 | 18 | 63 |
| CO2/CH4 selectivity in dirty gas | 9 | 5 | 28 | 15 | 30 | 17 |
| Crack evaluation score | OK | OK | OK | OK | OK | OK |
| | Ex5 | Ex6 | Ex7 | CEx3 | CEx4 | CEx5 |
| Porous Layer | PP | GMT | GMT | GMT | GMT | PP |
| Curable composition used to form the GL | — | RCC1 | RCC1 | RCC1 | RCC1 | — |
| Amount of curable composition applied to the porous | — | 6 mL/m2 | 6 mL/m2 | 6 mL/m2 | 6 mL/m2 | — |
| layer to form the GL | | | | | | |
| Dry thickness of the resultant GL | — | 600 nm | 600 nm | 600 nm | 600 nm | — |
| Composition used to form the DL | DSL3 | DSL1 | DSL2 | DSL1 | DSL2 | DSL3 |
| Amount of composition applied to the GL to form the DL | 10 mL/m² | 10 mL/m² | 10 mL/m² | 10 mL/m² | 10 mL/m² | 10 mL/m² |
| Dry thickness of the resultant DL | 55 μm | 100 nm | 100 nm | 100 nm | 100 nm | 55 μm |
| Curable composition used to form the PL | — | PL1 | PL1 | PL1 | PL1 | — |
| Amount of composition applied to the DL to form the PL | — | 9 mL/m² | 9 mL/m² | 9 mL/m² | 9 mL/m² | — |
| Dry thickness of the resultant PL | — | 595 nm | 595 nm | 595 nm | 595 nm | — |
| UV exposure time for the DL (seconds) | 0.7 | 0.7 | 0.7 | 0.7 | 0.7 | 0.7 |
| Power intensity of UV light used to cure the DL (mW/cm2) | 135 | 225 | 225 | 270 | 270 | 270 |
| CO2 flux (GPU) in clean gas | 44 | 20 | 43 | 40 | 105 | 109 |
| CO2/CH4 selectivity in clean gas | 25 | 37 | 27 | 15 | 8 | 7 |
| CO2 flux (GPU) in dirty gas | 63 | 18 | 63 | 70 | 240 | 260 |
| CO2/CH4 selectivity in dirty gas | 18 | 32 | 19 | 4 | 2.5 | 2.3 |
| Crack evaluation score | OK | OK | OK | NOK | NOK | NOK |

In Table 6 GL means gutter layer, DL means discriminating ayer and PL means protective layer.

1. A process for preparing a membrane comprising applying a composition comprising a polyimide to a gas-permeable support and irradiating the composition with UV-C light source to form a discriminating layer on the support, wherein:
(i) the UV-C light source emits light having a wavelength in the range 200 to 280 nm;
(ii) the irradiation is performed for a period of time in the range 0.05 to 60 seconds; and
(iii) the irradiation is performed at a power intensity of at least 20 mW/cm² and no more than 250 mW/cm².

2. A process according to claim 1 wherein the support comprises a porous layer and a gutter layer present on the porous layer, wherein the composition is applied to the gutter layer.

3. A process according to claim 1 wherein the gutter layer comprises dialkylsiloxane groups.

4. (canceled)

5. (canceled)

6. A process according to claim 1 which further comprises the step of applying a protective layer to the discriminating layer.

7. A process according to claim 1 wherein the average thickness of the discriminating layer is 20 nm to 2 μm.

8. A process according to claim 1 wherein the support comprises a porous layer and a gutter layer, wherein the gutter layer has an average thickness 25 to 1200 nm and is present on the porous layer.

9. A process according to claim 2 wherein the porous layer has pores of average diameter 0.001 to 0.1 μm

10. A process according to claim 1 wherein the polyimide comprises a repeat unit of the Formula (I): 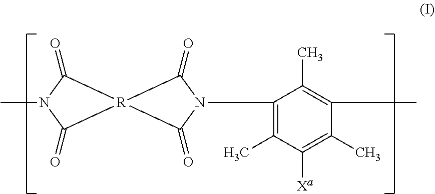
wherein:
each X^{a} independently is H, sulfamoyl, alkoxysulfonyl, carboxy, hydroxy, amide, sulphinic, sulphonic, thiol, acyloxy or halogen;
and
each R independently is a tetravalent linking group.

11. A process according to claim 1 wherein the discriminating layer is applied to the support by curtain coating, meniscus type dip coating, kiss coating, pre-metered slot die coating, reverse or forward kiss gravure coating, multi roll gravure coating, spin coating and/or slide bead coating.

12. (canceled)

13. A process according to claim 1 wherein the UV-C light source comprises a mercury vapour bulb.

14. A membrane obtained from a process according to claim 1.

15. (canceled)

16. A gas separation cartridge comprising a membrane according to claim 14.

17. A process according to claim 1 wherein the UV-C light emits light of higher intensity in the range 200 to 280 nm than in the ranges (i) 100 to 199 nm; and (ii) 281 to 315 nm.

18. A process according to claim 1 wherein the said irradiation is performed for a period of time in the range 0.1 to 30 seconds.

19. A process according to claim 1 wherein the said irradiation is performed at a power intensity of 100 to 250 mW/cm².

20. A process according to claim 1 wherein the said irradiation is performed for a period of time in the range 0.1 to 30 seconds and the UV-C light emits light of higher intensity in the range 200 to 280 nm than in the ranges (i) 100 to 199 nm; and (ii) 281 to 315 nm.

21. A process according to claim 1 wherein:
(a) the UV-C light emits light of higher intensity in the range 200 to 280 nm than in the ranges (i) 100 to 199 nm; and (ii) 281 to 315 nm;
(b) the said irradiation is performed for a period of time in the range 0.1 to 30 seconds; and
(c) the said irradiation is performed at a power intensity of 100 to 250 mW/cm².

22. A process according to claim 21 wherein:
(a) the average thickness of the discriminating layer is 20 nm to 2μm;
(b) the support comprises a porous layer and a gutter layer, wherein the gutter layer has an average thickness 25 to 1200 nm and is present on the porous layer; and
(c) the porous layer has pores of average diameter 0.001 to 0.1 μm.

23. A membrane obtained from a process according to claim 21.

24. A gas separation cartridge comprising a membrane according to claim 23.
